(19) United States
(12) Patent Application Publication
(10) Pub. No.: US 2004/0228113 A1
(43) Pub. Date: Nov. 18, 2004

(54) Reflective circuit board, and light module and flat panel display including the reflective circuit board

(75) Inventor: Chien-Chang Wang, Changhua (TW)

Correspondence Address: LIU & LIU LLP, 811 WEST SEVENTH STREET, SUITE 1100, LOS ANGELES, CA, 90017, US

(73) Assignee: Toppoly Optoelectronics Corp.

(21) Appl. No.: 10/844,294

(22) Filed: May 12, 2004

(30) Foreign Application Priority Data
May 15, 2003 (TW) 92113174

(51) Int. Cl. G03B 15/02

(52) U.S. Cl. 362/31

(57) ABSTRACT

A reflective circuit board, a light module including the circuit board, and a flat panel display including the circuit board. The reflective circuit board of the present invention includes: a circuit board body having a first surface and a second surface; a reflective layer attached to the first surface of the circuit board body; and an electric component disposed on the second surface of the circuit board body.

### BACKGROUND OF THE INVENTION

1. Field of the Invention

The present invention relates to flat panel displays, and more particularly to back light modules in flat panel displays with reflective structures.

2. Description of the Prior Art

FIG. 1 is a cross-section of a conventional liquid crystal display (LCD). The LCD includes, from the bottom to the top, a circuit board 100, a reflective sheet 600, a light guiding plate (LGP) 300, an optical sheet 400, and an LCD panel 500. The circuit board 100 includes a circuit board body 120 and an electric component 160. The circuit board body 120 has a first surface 100a and a second surface 100b, and the electric component 160 is disposed on the second surface 100b. The reflective sheet 600 includes, from the bottom to the top, a substrate 610, a reflective layer 620, and a protective layer 630. The optical sheet 400 includes one diffusion sheet 410 and two prism sheets 420 and 430.

A light source 200 is disposed on the side of the light guiding plate 300. The light pathway is described as follows. The light emitted from the light source 200 enters the light guiding plate 300 from the side of the light guiding plate 300, then, is reflected by the reflective layer 620 of the reflective sheet 600, enters the light guiding plate 300 again, passes the optical sheet 400, and enters the LCD panel 500.

However, the above-mentioned conventional liquid crystal display is very thick, and requires further improvement.

### SUMMARY OF THE INVENTION

The present invention is to improve the structure for reflecting light to the LCD panel, to overcome the drawbacks of the prior art. In accordance with the present invention, the circuit board is provided with a reflective surface to reflect light from the light guide plate to the LCD panel. A separate reflective sheet can be omitted.

In one embodiment of the present invention, the reflective circuit board includes: a circuit board body supporting an electric component, and having a first surface and a second surface; a reflective layer provided on or attached to the first surface of the circuit board body. The reflective layer extends over a substantial area, such as active area of an LCD panel, of the circuit board, to provide a uniform reflective area. In one embodiment, the electric component is disposed on the second surface of the circuit board body.

In another aspect of the present invention, a light module includes the reflective circuit board. The light module of one embodiment includes the above-mentioned reflective circuit board, a light source, and a light guiding plate. The light guiding plate is disposed on the reflective layer, such that light emitted from the light source passes the light guiding plate, is reflected by the reflective layer, and then reaches a first surface of the light guiding plate.

In still another aspect of the present invention, a flat panel display includes the reflective circuit board. The flat panel display of one embodiment includes the above-mentioned light module and a display panel. The display panel is disposed on the first surface of the light guiding plate.

### BRIEF DESCRIPTION OF THE DRAWINGS

The present invention will become more fully understood from the detailed description given hereinbelow and the accompanying drawings, given by way of illustration only and thus not intended to be limitative of the present invention.

FIG. 1 is a cross-section of a conventional liquid crystal display.

FIG. 2 is a cross-section of a flat panel display according to a first embodiment of the present invention.

FIG. 3 is a cross-section of a flat panel display according to a second embodiment of the present invention.

FIG. 4 is a schematic diagram illustrating an electronic device incorporating the flat panel display of the present invention.

### DETAILED DESCRIPTION OF THE INVENTION

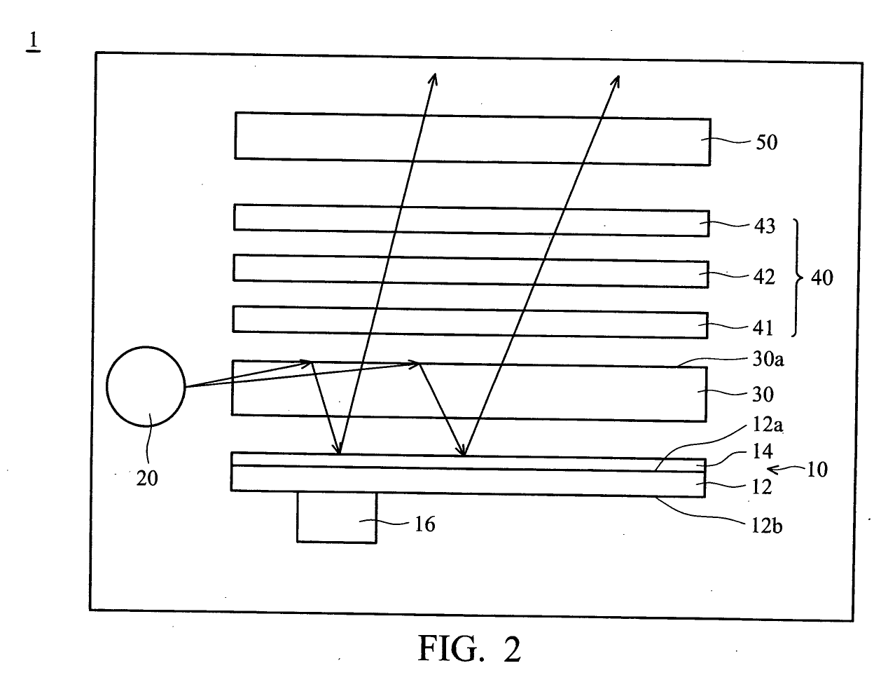

FIG. 2 is a cross-section of a flat panel display 1 according to a first embodiment of the present invention. The flat panel display 1, from the bottom to the top, includes a reflective circuit board 10, a light guiding plate (LGP) 30, an optical sheet 40, and a display panel 50. In addition, a light source 20 is disposed on the side of the light guiding plate 30.

The reflective circuit board 10 includes a circuit board body 12, a reflective layer 14, and an electric component 16. The circuit board body 12 has a first surface 12a and a second surface 12b. The reflective layer 14 is provided on or attached to the first surface 12a of the circuit board body 12, and the electric component 16 is disposed on the second surface 12b of the circuit board body 12. (Even though FIG. 2 schematically shows only one electronic component 16, there may be a plurality of discrete electronic components on second surface 12b.) The reflective area of the circuit board extend over substantially the area of the LCD panel or the viewing area thereof, so as to provide an uniform reflective layer over the viewing area of the LCD panel.

Typically, the optical sheet can include a diffuser sheet, a prism sheet, or a combination thereof. The diffuser sheet has a light scattering effect for evenly distributing the light emitted from the light source, and the prism sheet focuses scattered light to a certain degree to enhance the brightness. For example, in FIG. 2, the optical sheet 40 includes one diffuser sheet 41 and two prism sheets 42 and 43.

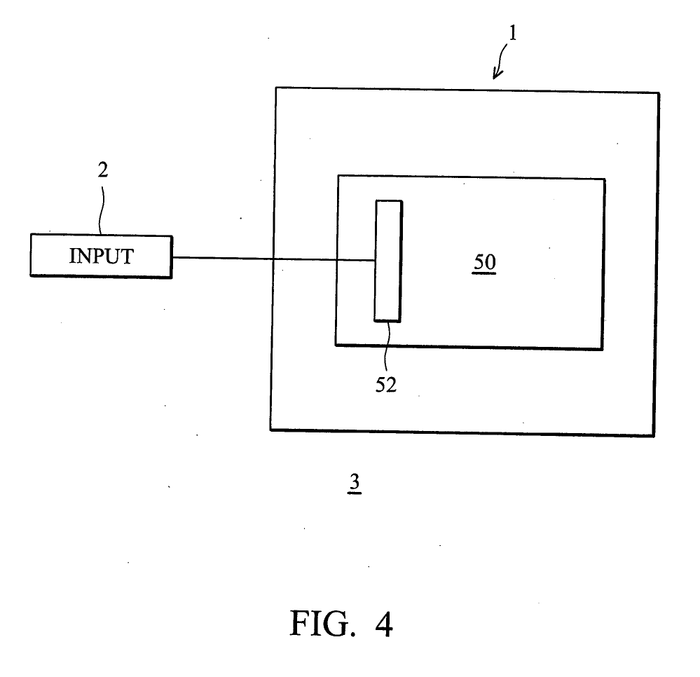

FIG. 4 is a schematic diagram illustrating an electronic device 3 incorporating the flat panel display 1 of FIG. 2. Referring to FIG. 4, the display panel 50 can be an LCD display panel and include a controller 52. The controller 52 can comprise a source and gate driving circuits (not shown) to control the display panel 50 to render image in accordance with an input. An input device 2 is coupled to the controller 52 in the display panel 50 of the flat panel display 1 shown in FIG. 2 to form an electronic device 3. The input device 2 can include a processor or the like to input data to the controller 52 to render an image. The electronic device 3 may be a portable device such as a PDA, notebook computer, tablet computer, cellular phone, or a display monitor device, or non-portable device such as a desktop computer.

The circuit board body 12 can be a rigid circuit board or a flexible circuit board. The electric component 16 can be resistors, capacitors, IC controllers, and the like.

The pathway of light is described as follows. Light emitted from the light source 20 enters the light guiding plate 30 from the side of the light guiding plate 30, and is reflected at the surface 30a towards the circuit board 10. Light is reflected by the reflective layer 14 of the reflective circuit board 10, enters the light guiding plate 30 again, passes the optical sheet 40, and enters the LCD panel 50.

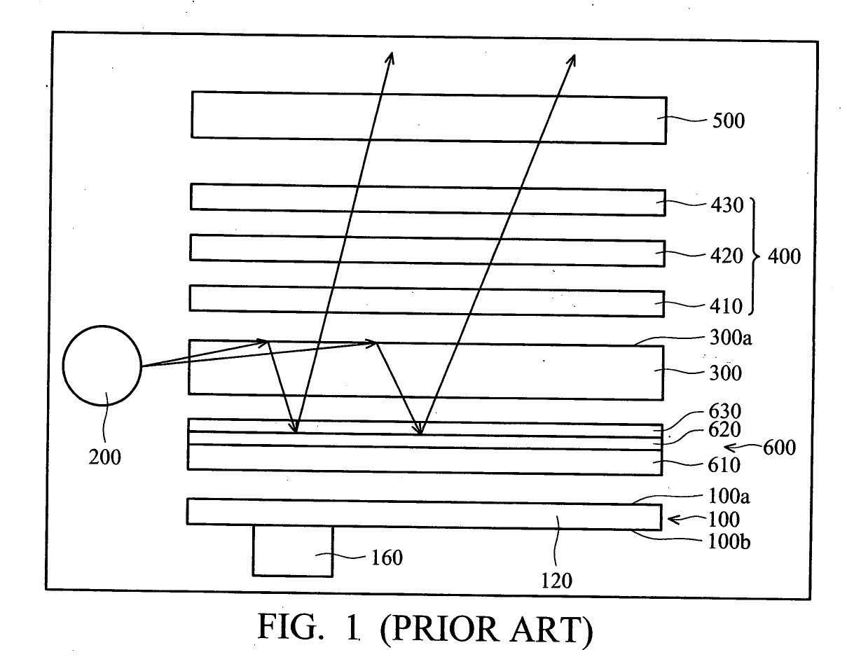

The feature of the present invention resides in that the circuit board provides a reflective function, so that a separate reflective sheet can be omitted, thus reducing the thickness of the light module or flat panel display. Referring to FIG. 1 of the conventional flat panel display, the reflective layer 620 is disposed on the reflective substrate 610, and the circuit board 100 does not have a reflective function. As to FIG. 2 of the flat panel display 1 of the present invention, the reflective layer 14 is directly attached to the circuit board body 12 to make the circuit board 10 reflective. Therefore, as shown in FIG. 2, the reflective substrate 610 does not need to be disposed in the same manner as shown in FIG. 1. Thus, in the present invention, the thickness of the reflective substrate 610 is omitted, greatly reducing the thickness of the entire light module or the flat panel display.

According to the present invention, the reflective layer 14 can be an inorganic material. Representative examples include titanium dioxide, aluminum oxide, zinc oxide, zinc sulfide, barium sulfate, antimony oxide, magnesium oxide, magnesium fluoride, calcium, and combination thereof. The reflective layer 14 can also be a metal or a metal alloy. Representative examples include silver, silver alloy, aluminum, aluminum alloy, and combination thereof.

The reflective layer 14 can be formed by coating, deposition, or electroplating to be provided on or attached to the first surface 12a of the circuit board body 12. For example, the reflective layer 14 can be formed by plasma coating, spray coating, gel coating, conversion coating, chemical vapor deposition (CVD), or sputtering. Or, the reflective layer 14 can be attached to the first surface 12a of the circuit board body 12 by adhesion. The reflective layer 14 can have a thickness of 1 to 10 μm, preferably 1 to 5 μm.

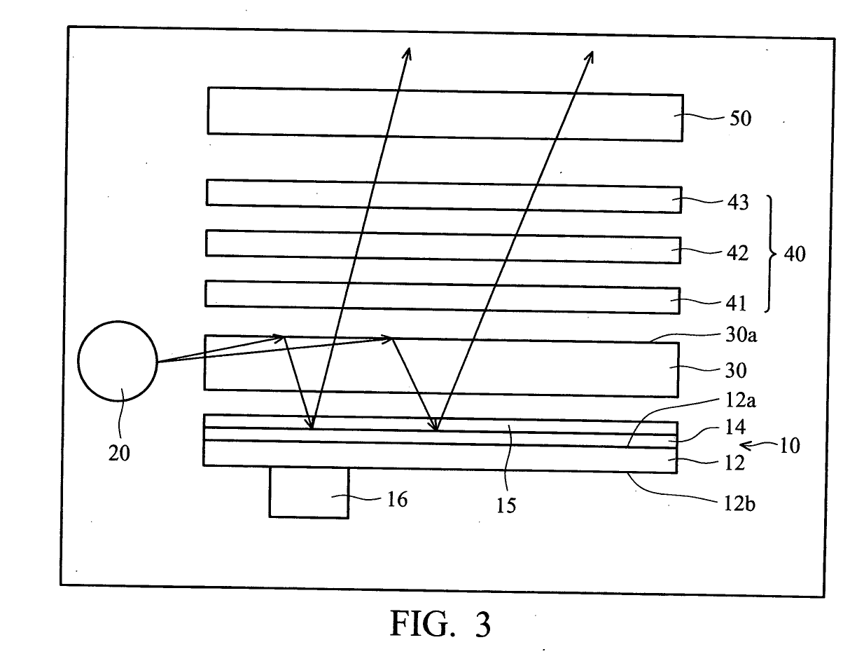

FIG. 3 is a cross-section of a flat panel display according to a second embodiment of the present invention. The flat panel display, from the bottom to the top, includes a reflective circuit board 10, a light guiding plate 30, an optical sheet 40, and a display panel 50. In addition, a light source 20 is disposed on the side of the light guiding plate 30.

The reflective circuit board 10 includes a circuit board body 12, a reflective layer 14, a transparent protective layer 15, and an electric component 16. The circuit board body 12 has a first surface 12a and a second surface 12b. The reflective layer 14 is attached to the first surface 12a of the circuit board body 12, the protective layer 15 is attached to the reflective layer 14, and the electric component 16 is disposed on the second surface 12b of the circuit board body 12.

The flat panel display structure of FIG. 3 is similar to FIG. 2, and detailed descriptions are omitted herein. The difference resides in that in FIG. 3, a transparent protective layer 15 is attached to the reflective layer 14. The protective layer 15 can be a polymer, such as polyester, polyethylene (PE), polypropylene (PP), or acrylic polymer and formed by surface coating, spraying, compressing, or UV curing.

In conclusion, the present invention combines the reflective sheet and the circuit board in the conventional flat panel display into a single element by directly disposing a reflective layer on the circuit board. Therefore, the present invention saves the thickness of a reflective substrate, thus greatly reducing the entire thickness of the light module or the flat panel display.

The foregoing description of the preferred embodiments of this invention has been presented for purposes of illustration and description. Obvious modifications or variations are possible in light of the above teaching. For example, it is conceivable that electronic components may be provided on the surface facing the light guide plate, and such surface is planarized made reflective (e.g., coating or attaching a reflective layer) to provide a smooth reflective surface. The embodiments chosen and described provide an excellent illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A reflective circuit board, comprising:
a circuit board body having a first surface and a second surface; wherein the first surface is reflective over a substantial area of the circuit board body; and
an electric component supported on the circuit board body.

2. The reflective circuit board as claimed in claim 1, wherein the circuit board body is a rigid circuit board or a flexible circuit board.

3. The reflective circuit board as claimed in claim 1, wherein the reflective surface comprises an inorganic material.

4. The reflective circuit board as claimed in claim 3, wherein the inorganic material in the reflective surface is selected from the group of titanium dioxide, aluminum oxide, zinc oxide, zinc sulfide, barium sulfate, antimony oxide, magnesium oxide, magnesium fluoride, calcium carbonate, and combination thereof.

5. The reflective circuit board as claimed in claim 1, wherein the reflective surface comprises a metal or a metal alloy.

6. The reflective circuit board as claimed in claim 5, wherein the reflective surface comprises metal or metal alloy selected from the group of silver, silver alloy, aluminum, aluminum alloy, and combination thereof.

7. The reflective circuit board as claimed in claim 1, wherein the reflective surface comprises a layer formed by coating, deposition, or electroplating to be attached to the first surface of the circuit board body.

8. The reflective circuit board as claimed in claim 1, wherein the reflective surface comprises a reflective layer attached to the first surface of the circuit board body by adhesion.

9. The reflective circuit board as claimed in claim 8, wherein the reflective layer has a thickness of 1 to 10 μm.

10. The reflective circuit board as claimed in claim 8, further comprising a protective layer attached to the reflective layer.

11. A light module comprising:
the reflective circuit board as claimed in claim 1;
a light source; and
a light guiding plate disposed in operative relationship to the reflective circuit board, such that light emitted from the light source passes the light guiding plate, is reflected by the reflective surface of the reflective circuit board, and then reaches a first surface of the light guiding plate.

12. A flat panel display comprising:
the light module as claimed in claim 11; and
a display panel disposed in operative relationship with the light module.

13. An electronic device, comprising:
the flat panel display as claimed in claim 12;
a controller operatively coupled to the flat panel display, controlling the operation of the flat panel display; and
a source of image data providing image data to the controller to render an image on the flat panel display.
